(19) United States
(12) Patent Application Publication
(10) Pub. No.: US 2003/0117910 A1
(43) Pub. Date: Jun. 26, 2003

(54) Optical disk drive and servo control method

(76) Inventor: Yasuo Oishi, Fukuoka (JP)

Correspondence Address: RATNERPRESTIA, P O BOX 980, VALLEY FORGE, PA, 19482-0980, US

(21) Appl. No.: 10/317,663

(22) Filed: Dec. 10, 2002

(30) Foreign Application Priority Data
Dec. 21, 2001 (JP) 2001-389145

(51) Int. Cl. G11B 7/095

(52) U.S. Cl. 369/44.26; 369/53.28

(57) ABSTRACT

The present invention provides an optical disk drive capable of preventing breakdown in a transient response state, and its tracking and focus control method. The optical disk drive comprises an ODC which takes the timing of variation in signal amplitude of tracking error signal or focus error signal as process start timing to meet a demand for data recording or a demand for data reading, and a hold timing signal output circuit which generates a mask signal to hold the tracking control or the focus control in timing before or after variation of the signal amplitude.

### FIELD OF THE INVENTION

The present invention relates to an optical disk drive for reading or recording information of DVD, CD or the like, and its tracking servo control method.

### BACKGROUND OF THE INVENTION

Generally, in an optical disk recording system and a reproducing system, laser beam reflected from an optical disk is used for the control of writing data into an optical disk and for the control of reproducing data recorded on the optical disk. However, in the case of a reproducing system in particular, there is a great difference in the amount of reflected laser beam between the area where the recorded data exists and the area where no recorded data exists in the optical disk. Also, the amount of laser beam radiated from the laser is remarkably increased during recording as compared with the amount of laser beam radiated during reproducing, and as a result, the amount of reflected laser beam is so much increased during writing control.

In a conventional optical disk drive, follow-up control (hereafter referred to as tracking control) and focus control to a data spirally recorded on the optical disk is executed by using reflected laser beam. Generally, a controlling signal input to a tracking control circuit and a focus control circuit is a signal obtained by converting the amount of reflected laser beam into an electric signal (hereafter referred to as servo signal). For both of the control systems to be reliably operated at all times, it is desirable that the servo signal is free from fluctuations. In a conventional optical disk drive, AGC (Automatic Gain Control) circuit is employed in order to eliminate servo signal fluctuations and to make the amplitude level of the servo signal stable at all times.

FIG. 6 is a block diagram of a conventional optical disk drive. In FIG. 6, optical pickup 602 applies a laser beam to optical disk 601 to record or reproduce data, which is in one piece with a detector. Carriage 602a engages screw shaft 603, and as the screw shaft 603 is rotated, the optical pickup 602 moves radially of the optical disk 601. Traverse motor (Trs motor for short) 604 rotates the screw shaft 603. RF signal generating block 605 generates RF signal that is used as source signal for reproducing the data based on the detection signal of the optical pickup 602. AS signal generating block 606 generates AS signal that is the sum total of the detection signal output from the detector in the optical pickup 602. TE signal generating block 607 generates controlling signal in the tracking direction. FE signal generating block 608 generates controlling signal in the focal direction. Trs signal generating block 609 generates controlling signal for traverse drive. AGC block 610 controls the focus controlling signal and tracking control signal, making the signals constant in amplitude. Control block 611 controls the signal generation at each of the above blocks.

Traverse driver (Trs driver for short) 612 applies a drive voltage to traverse motor (Trs motor for short) 604. Traverse servo (Trs servo for short) 613 executes the traverse control of carriage 602a (or optical pickup 602). Focus driver (Fo driver for short) 614 drives a focus actuator (not shown). Focus servo (Fo servo for short) 615 executes the focus control of the optical pickup 602. Tracking driver (Tr driver for short) 616 drives a tracking actuator (not shown). Tracking servo (Tr servo for short) 617 executes the tracking control of the optical pickup 602.

Signal shaping block 618 shapes RF signal generated by the RF signal generating block 605. Control block 619 in the servo circuit controls each of the above servo circuits. Optical disk controller (hereafter referred to as ODC) 620 controls the whole reproduce processing such as data delivery and error correction in relation with host computer (host PC for short) 622. Central processing unit (CPU for short) 621 controls the whole optical disk drive.

Next, the tracking control operation and the focus control operation in a conventional optical disk drive are described hereinafter with reference to FIG. 6. Laser beam radiated from the optical pickup 602 to the optical disk 601 is modulated by the information of optical disk 601, then the laser beam is reflected and again enters the optical pickup 602. An optical detector (not shown) built in the optical pickup 602 detects and converts the incident beams to electrical displacement signals and outputs the signals. These displacement signals are processed and used for purposes such as focus control, tracking control later described and RF signal generating to obtain the information recorded on the optical disk.

The focus control, tracking control, RF signal generating and AS signal generating operations are described in the following.

Each of the above controls is needed for displacement information detected by the optical detector, and the displacement information is the one converted from optical displacement information to electrical displacement information (current displacement). An I/V converter (not shown) is built in the optical pickup 602, and converts the current displacement information to voltage displacement information. TE signal generating block 607 generates tracking error signal (hereafter referred to as TE signal) that is the information of positional deflection in the widthwise direction of the track of the optical pickup 602 from the pit spirally carved in the optical disk 601 in accordance with the voltage displacement information.

Also, FE signal generating block 608 generates focus error signal (hereafter referred to as FE signal) that is the information of deflection of the optical focal distance of the optical pickup 602 from the pit. RF signal generating block 605 generates data (hereafter referred to as RF signal) itself carved in the optical disk 601. Next, AS signal generating block 606 generates all-sum signal (hereafter referred to as AS signal) that is a signal for detecting the change in amount of the reflected laser beam from the optical disk 601.

Generally, a plurality of optical detection elements are laid out according to the detection system, and the signals generated by these optical detection elements are combined and computed to generate control signals such as RF signal, TE signal, and FE signal. The TE signal and FE signal are respectively used as controlling signals in tracking control and focus control. The RF signal is used as analog source signal for digitally processing the data information carved in the optical disk 601. The AS signal is all-sum signal that is obtained by adding all the generated signals of the optical detection elements contributing to the generation of data and control signals (that is, RF signal, TE signal, FE signal).

Here, tracking control is first explained. The TE signal generated by the TE signal generating block 607 and the AS signal generated by the AS signal generating block 606 are handed over to AGC (Automatic Gain Control) block 610. FIG. 7 is a block diagram of AGC block 610 of the optical disk drive shown in FIG. 6. In FIG. 7, TE signal 706 and FE signal 708 input to the AGC block 610 are respectively amplified by TE amplifier 701 and FE amplifier 703, and subjected to gain setting, at TE AGC section 702 and FE AGC section 704, to output levels suited for the respective controls.

AS signal 710 input to AGC block 610 is used as a control signal as described in the following.

First, AS ATT section 705 determines the level that is a reference for control signals on the basis of AS signal 710. This reference level is an appropriate signal level of AS signal in either the area with recorded data or the area without recorded data in the optical disk 601. Since AS signal 710 differs in the amount of reflected laser beam between the area with recorded data and the area without recorded data in the optical disk 601, the signal level changes depending upon the movement of the optical pickup 602. Regarding TE signal 706 and FE signal 708 as well, the level of signal amplitude changes because of similar reasons.

Incidentally, the ratio of the level variation of AS signal 710 generated in the area with recorded data and the area without recorded data of the optical disk 601 to the level variation of TE signal 706 and FE signal 708 is physically constant at all times. That is, the ratio of the signal level of TE signal 706 to the signal level of AS signal 710 is constant, and the ratio of the signal level of FE signal 708 to the signal level of AS signal 710 is constant. And, TE AGC section 702 and FE AGC section 704 adjust the respective gains in accordance with the control signal of variation information of AS signal 710 supplied from AS ATT section 705, and respectively generate TE age signal 707 without variation in signal amplitude and FE age signal without variation in signal amplitude.

In this way, TE age signal without amplitude variation, generated by AGC block 610, is input to tracking servo block 617. The tracking servo block 617 comprises digital servo filter circuits for specifically realizing the classical servo theory, and the TE age signal input is used as controlling signal. TE age signal 707 shows the information itself of deviation in the track direction of laser beam to the pit formed as data information in the optical disk 601. Since the TE agc signal 707 shows the information itself of deviation of laser beam from the pit in the direction of disk radius, when the spot of laser beam moves from a certain track to an adjacent track, variation for one cycle of sine waveform appears in the TE agc signal 707.

That is, a tracking actuator (not shown) built in the optical pickup 602 drives the optical pickup 602 in the tracking direction (disk radius direction) to control so that the amplitude variation of TE agc signal is suppressed to be extremely small in amplitude level deviation, and thereby, the track direction control is executed with respect to the pit formed as data information in the optical disk 601. Tracking servo block 617 executes such control, and outputs a signal necessary for controlling the tracking actuator (not shown). Tracking driver 616 sets the signal to an appropriate signal level and drives the tracking actuator, thereby executes the tracking control.

Focus control is described in the following. FE signal 708 generated by FE signal generating block 608 is handed over to AGC (Automatic Gain Control) block 610 together with AS signal 710, and FE agc signal without signal amplitude variation is output from FE AGC section 704. The FE agc signal is input to focus servo 615.

The focus servo 615 comprises digital servo filter circuits for specifically realizing the classical servo theory the same as in tracking servo 617. Input FE agc signal 709 is used as controlling signal, showing the information of deviation in optical focal distance from the optical pickup 602 to the pit formed as data information in the optical disk 601, and fluctuates in shape of sine wave deppending upon distance between them.

A focus actuator (not shown) built in the optical pickup 602 drives the optical pickup 602 in the focus direction (vertical direction) to control so that the amplitude variation of TE agc signal 709 is suppressed to be extremely small in amplitude level deviation. Thus, the focus direction control is executed with respect to the pit formed as data information in the optical disk 601. Focus servo block 615 executes such control, and outputs a signal necessary for controlling the focus actuator (not shown). Focus driver 614 sets the signal to an appropriate signal level and drives the focus actuator, thereby executing the focus control.

Next, RF signal is explained in the following. Signal shaping block 618 executes an equalizer process (not shown) for eliminating analog signal noise in RF signal generated by RF signal generating block 605, followed by binary process (not shown) for conversion from analog information to digital information, and delivers the information to ODC (Optical Disk Control) 620.

ODC 620 handles the data carved in the optical disk 601 as digital data, and executes the processes such as data error correction, demodulation, and descrambling, and then delivers the information as original data information to host PC 622.

Here, for the control of the optical disk drive, it is necessary to have a control for moving the optical pickup 602 at a high speed to the area where the intended data exists in order to have access to data widely existing in the optical disk 601 (hereafter referred to as seek control). Such a high-speed movement of the optical pickup 602 is executed as screw shaft 603 is rotated by traverse motor 604 and then carriage 602a with the optical pickup 602 mounted thereon moves on the screw shaft 603. In seek control, TE signal and the signal output from the sensor (not shown) externally disposed are used as controlling signal.

The seek control is further described in the following. The difference between the present position address and the target address is converted into the number of tracks. Since the number of tracks traversed by the optical pickup 602 is obtained by counting the crests and bottoms of the TE signal amplitude, the traverse motor 604 is rotated for the necessary count value to move the carriage 602a.

Also, in the case of following up the data spirally carved in the optical disk 601, that is, executing the tracking control, it is necessary to execute control (hereafter referred to as traverse control) for moving the carriage 602a little by little. In the traverse control, traverse signal (Trs signal for short) that is low frequency component of TE signal is used.

Next, the traverse control is described in the following. Since data is spirally recorded on the optical disk 601, as the data is continuously read, it becomes necessary to move the carriage 602a with the optical pickup 602 mounted thereon little by little from the inner periphery to the outer periphery.

Generally, the optical pickup 602 is movable on the carriage 602a in both of the track direction and the focus direction within a certain range. However, when the optical pickup 602 makes movement (hereafter referred to as lens shift) on the carriage 602a due to the tracking control, low frequency component of TE signal fluctuates.

That is, traverse control can be executed by extracting the low frequency component of TE signal to generate Trs signal that is the controlling signal for traverse control and by giving the variation of Trs signal as traverse drive signal to the traverse servo 613. In this way, traverse control processing is executed by the traverse servo 613, and by giving appropriate gain to the traverse driver 612, and thereby, the follow-up movement of the carriage by tracking control may be executed with respect to the carriage 602a.

In a conventional optical disk drive, a series of control systems cooperate with each other as described above for reading and writing of data in the optical disk 601. However, in the case of tracking control and focus control in the conventional optical disk drive, a control method according to the classical control theory is usually employed. Accordingly, when the signal that becomes the controlling signal input to the control section is fluctuated, there may arise a problem of servo oscillation or servo breakdown because of constant gain.

In all of optical disks capable of recording, represented by CD-R/RW and DVD-R/RW, it is known that the area with recorded data and the area without recorded data in the disk are greatly different in TE signal amplitude. Also, in the shifting process from reproducing mode to recording mode, the tracking error signal (TE signal) and the focus error signal (FE signal) are considerably fluctuated due to the variation of the laser power.

In order to cope with this problem, in a conventional optical disk drive, the variation of TE signal or FE signal is absorbed by AGC (Automatic Gain Control) circuit. However, it is unable to avoid the occurrence of such problem that a transient state continues for a while after the generation of signal variation until stabilizing of the signal variation by the AGC circuit. During the period of transient state, the signal variation is not yet fully stabilized by the AGC, and the signal levels of TE signal and FE signal are in a state of variation. Even in such a short period of time until stabilizing of signal variation, if the signal is greatly fluctuated, the TE signal and FE signal input cause considerable variation of the servo gain in the tracking control and focus control circuits. However, since the gain set in the tracking control and focus control circuits is constant, there has been a fear of tracking servo and focus servo oscillation or servo breakdown.

### SUMMARY OF THE INVENTION

An optical disk drive comprises a control section which takes the fluctuation timing of the signal amplitude of servo error signal as the process start timing to meet the demands for data reproducing and data reading, and a hold timing signal output circuit which generates a mask signal for holding the servo driving signal. The servo control method of the optical disk drive comprises the steps of timing setting for setting the timing of mask signal output, and of hold time setting for setting the time of holding the servo control, wherein a mask signal is generated for holding the servo in accordance with settings in the timing setting step and the hold time setting step when the control section takes the process start timing.

### BRIEF DESCRIPTION OF THE DRAWINGS

FIG. 1 is a block diagram of the optical disk drive in the exemplary embodiments 1 and 2 of the present invention.

FIG. 2 is a block diagram of the hold timing signal output circuit in the optical disk drive of FIG. 1.

FIG. 3 is a block diagram of the servo hold circuit in the optical disk drive of FIG. 1.

FIG. 4 is a diagram showing the alteration of AS signal and TE signal during transfer from a recorded area to a non-recorded area of the optical disk drive in the exemplary embodiment 2 of the present invention.

FIG. 5 is a flow chart of servo hold processing in the exemplary embodiments 1 and 2 of the present invention.

FIG. 6 is a block diagram of a conventional optical disk drive.

FIG. 7 is a block diagram showing the AGC block in the optical disk drive of FIG. 6.

### DETAILED DESCRIPTION OF THE EXEMPLARY EMBODIMENTS

Exemplary Embodiment 1

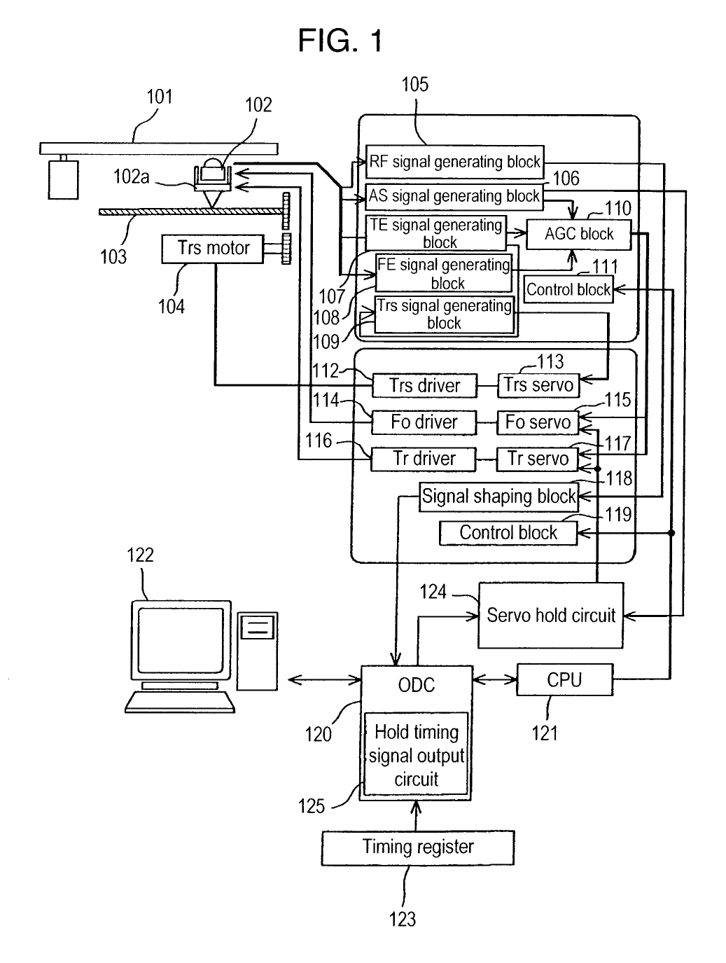

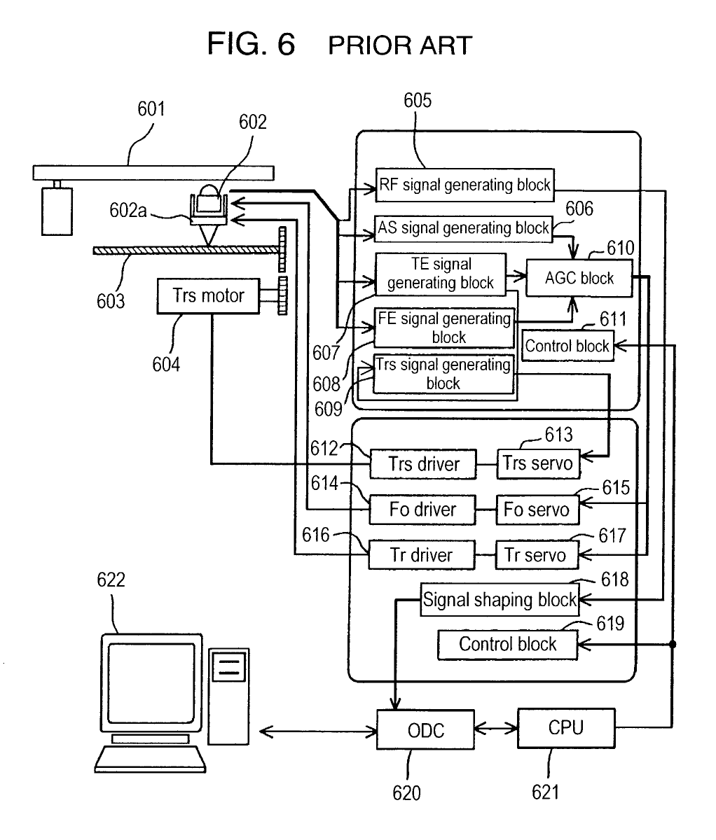

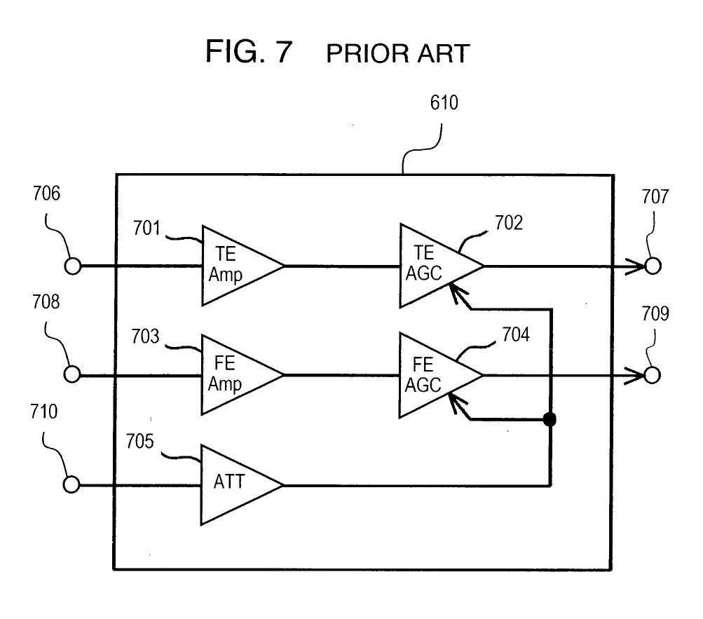

The exemplary embodiment of the present invention is described hereinafter with reference to FIGS. 1, 4, 5. FIG. 1 is a block diagram of the optical disk drive in the exemplary embodiments 1 and 2 of the present invention. In FIG. 1, optical disk 101, optical pickup 102, carriage 102a, shaft 103, traverse motor 104, RF signal generating block 105, AS signal generating block 106, TE signal generating block 107, FE signal generating block 108, Trs signal generating block 109, AGC block 110, signal generating circuit control block 111, traverse driver 112, traverse servo 113, focus driver 114, focus servo 115, tracking driver 116, tracking servo 117, signal shaping block 118, servo circuit control block 119, optical disk controller ODC 120, CPU 121, and host PC 122 are respectively identical with the optical disk 601, optical pickup 602, carriage 602a, shaft 603, traverse motor 604, RF signal generating block 605, AS signal generating block 606, TE signal generating block 607, FE signal generating block 608, Trs signal generating block 609, AGC block 610, signal generating circuit control block 611, traverse driver 612, traverse servo 613, focus driver 614, focus servo 615, tracking driver 616, tracking servo 617, signal shaping block 618, servo circuit control block 619, optical disk controller ODC 620, CPU 621, and host PC 622 of FIG. 6, and the detailed description of these is be omitted. Also, the basic principles of operation of the tracking control and focus control are same as in FIG. 6, and the detailed description is omitted.

Timing register 123 sets the hold timing signal output from the ODC 120. Servo hold circuit 124 functions to temporarily hold the drive of focus control and tracking control. Due to the holding function of the servo hold circuit 124, the driving signals of focus control and tracking control are respectively maintained at the fixed values or the present driving signal levels.

Next, in the optical disk drive of the exemplary embodiment 1, description is made with respect to holding of the tracking control and the focus control in transfer from data reproducing out of the optical disk 601 to data writing into the optical disk 601. And, in the case of transfer from writing to reproducing, only required is to reverse the control operation, and there is no substantial difference in the description. Also, the optical disk drive of the exemplary embodiment 1 holds the tracking control and the focus control by switching the servo hold circuit even in the case of inrush of the optical pickup from the data recorded area to the data non-recorded area during normal reading mode. This is described in the exemplary embodiment 2.

Hold timing signal output circuit 125 in ODC 120 operates in accordance with the value set in the timing register 123 and generates hold timing signals. The hold timing signal is supplied to the servo hold circuit 124.

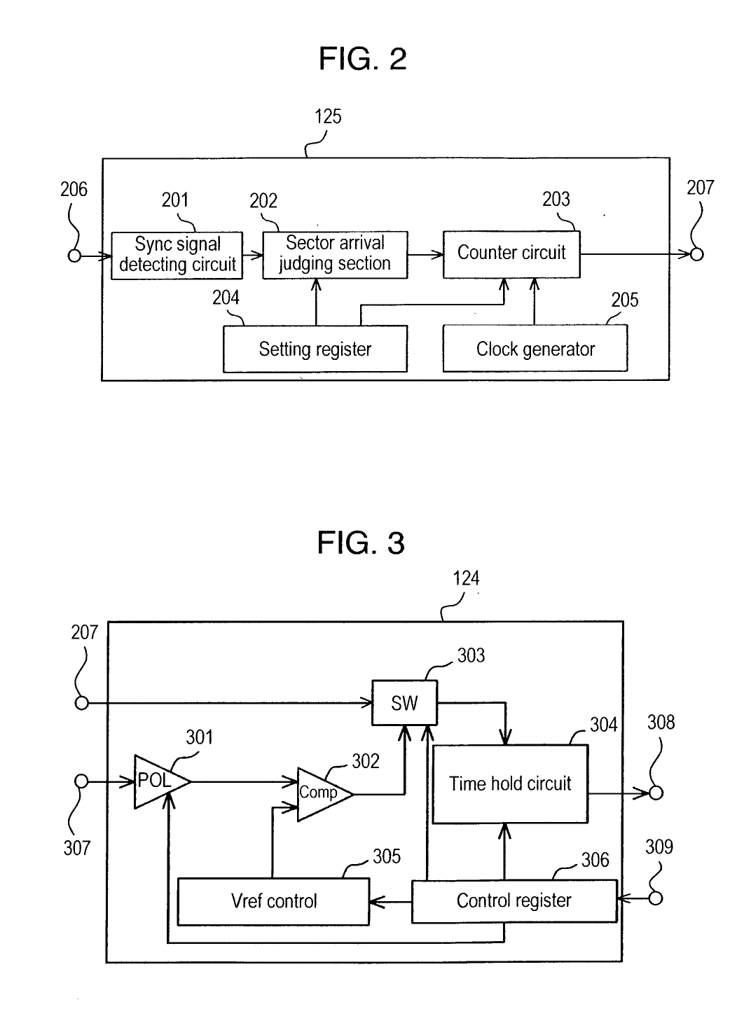

FIG. 2 is a block diagram of the hold timing signal output circuit 125 in the optical disk drive of FIG. 1. In FIG. 2, the hold timing signal output circuit 125 comprises sync signal detecting circuit 201, sector arrival judging section 202, counter section 203, setting register 204, and clock generater 205. The sync signal detecting circuit 201 receives shaped RF signal 206 from the signal shaping block 118 and detects the sync signal data (hereafter referred to as sync data) carved for synchronous detection in every sector that is one unit of the data carved in the optical disk 101.

Sector arrival deciding section 202 decides the arrival of the sector needed to output the hold timing signal in accordance with the detected sync data. Counter section 203 decides the output timing of hold timing signal 207 at an predetermined position of an predetermined sector. Setting register 204 sets the parameters that are used for the output at the sector arrival deciding section 202 and the counter section 203. Clock generater 205 feeds the counter clock signal to the counter section 203.

The operation of the hold timing signal output circuit 125 is described hereinafter with reference to FIG. 2. The ODC 120 of FIG. 1 controls the writing start timing itself and is able to output the hold timing signal in timing prior to the start of writing for the set sector.

That is, ODC 120 takes the process start timing of writing operation or reproducing operation to meet the demand for data recording or data writing from the host PC 122 as the fluctuation timing of the signal amplitude of TE signal or FE signal in order to decide the fluctuation timing. And, CPU 121 is able to execute this control in place of ODC 120. Accordingly, it corresponds to the control section of the present invention comprising ODC 120 or CPU 121 which is a means of serving the function according to the control program.

When the number of sectors equivalent to the process start timing set in the setting register 204 is reached, the sector arrival deciding section 202 delivers the sync signal output from the sync signal detecting circuit 201 to the counter section 203. The counter section 203 receives the output timing information in the sector set by the setting register 204. The counter section 203 starts counting on inputting of sync signal. When the output sector timing that shows the sector of output position is reached, a sector output timing counter (not shown) located in the counter section 203 starts counting operation, and when the sector output timing is reached, hold timing signal 207 is output to the servo hold circuit 124 of FIG. 1.

Thus, in the hold timing signal output circuit 125, ODC 120 to control the writing start timing itself is utilized to output the hold timing signal 207 in timing prior to the writing start timing or just after generation of fluctuation, and in this way, it is possible to flexibly output the signal before or after the writing start timing.

The hold timing signal 207 output from the hold timing signal output circuit 125 is delivered to the servo hold circuit 124 of FIG. 1. The servo hold circuit 124 controls the tracking servo 117 in order to maintain the output of tracking driver 116 in a present state for only a specific period of set-time with the hold timing signal 207 input. Similarly, the servo hold circuit 124 controls the focus servo 115 in order to maintain the output of focus driver 114 in a present state for only a specific period of set-time with the hold timing signal 207 input.

FIG. 3 is a block diagram of the servo hold circuit 124 of the optical disk drive in FIG. 1.

The operation of the servo hold circuit is described hereinafter with reference to FIG. 3.

In FIG. 3, the servo hold circuit 124 comprises AS polarity switching section (or POL) 301, comparator 302, switch (or SW) 303, time hold circuit 304, area deciding reference signal level setting section (or Vref control) 305, and control register 306. The AS polarity switching section (or POL) 301 is controlled by the control register 306, and switches the polarity of AS signal 307 supplied from the AS signal generating block 106, and supplies it to the comparator 302. The comparator 302 compares the area deciding reference signal output from the area deciding reference signal level setting section 305 with the AS signal output from The POL 301.

The switch (SW) 303 is controlled by the control register 306, and changes over the hold timing signal 207 from the hold timing signal output circuit 125 and the output of comparator 302. Changeover setting demand control signal 309 fom ODC 120 of FIG. 1 is delivered to the control register 306, and the control register 306 controls the changeover at the switch (SW) 303. This changeover control is same means as the hold timing output circuit 125 and executes the changeover in timing prior to inputting of the hold timing signal 207.

The switch 303 selects the output of comparator 302 when controlling the servo variation during inrush from the data recorded area to the data non-recorded area in the normal reproducing mode of the optical disk 101. This is described in the exemplary embodiment 2. The hold timing signal 207 is delivered to the time hold circuit 304 via the switch 303.

The time hold circuit 304 generates a pulse signal with a time width set by the control register 306, starting from the rising edge or falling edge of the hold timing signal 207, and supplys the signal as mask signal 308. The mask signal 308 is supplied to the traverse servo 113 and the focus servo 115 of FIG. 1. The traverse servo 113 and the focus servo 115 which have received the mask signal act upon the traverse driver 112 and the focus driver 114 so as to drive and hold the tracking control and focus control in a state of present drive or at an predetermined fixed-value level within the pulse width period of mask signal 308.

In this way, during transfer from data reproducing out of the optical disk 101 to data writing into the optical disk 101, the tracking control and the focus control are held when the TE signal and FE signal generated by AGC block 110 are in a transient state. As a result, it is possible to prevent the oscillation and breakdown of the servo system in a transient state.

Exemplary Embodiment 2

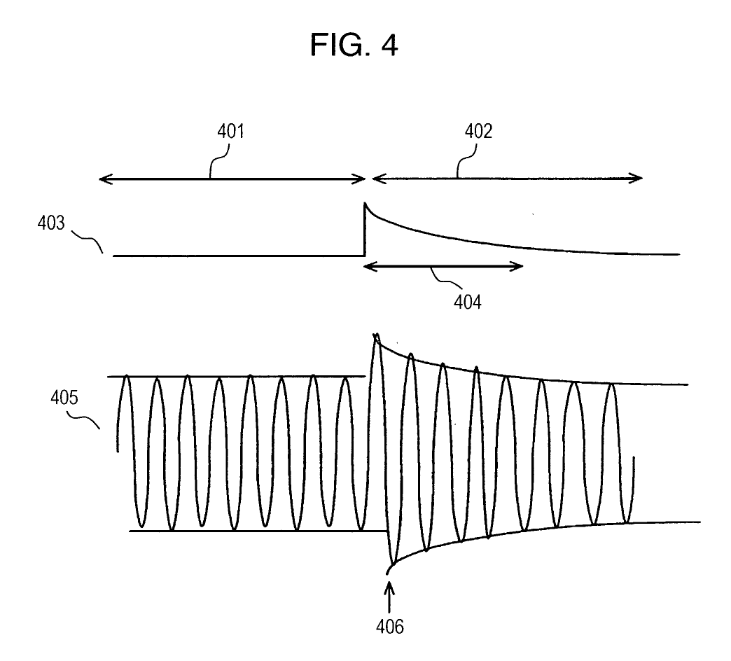

FIG. 4 is a diagram showing the alteration of AS signal and TE signal in the operation of AGC circuit during transfer from the recorded area to the non-recorded area of the optical disk drive in the exemplary embodiment 2 of the present invention.

In FIG. 4, AS signal level 403 shows the signal level of AS signal 307 in relation with the lapse of time. Period 401 is the period of scanning the data writing area by the optical pickup in normal reproducing mode, and period 402 is the period of scanning the non-recorded area by the optical pickup. Period 404 is the period of a transient response state of TE signal 405 until being stabilized by the AGC circuit 110 to a constant amplitude level. Time 406, if taken as the point of transfer from normal reproducing to writing, is showing a transient state of the exemplary embodiment 1 in FIG. 4.

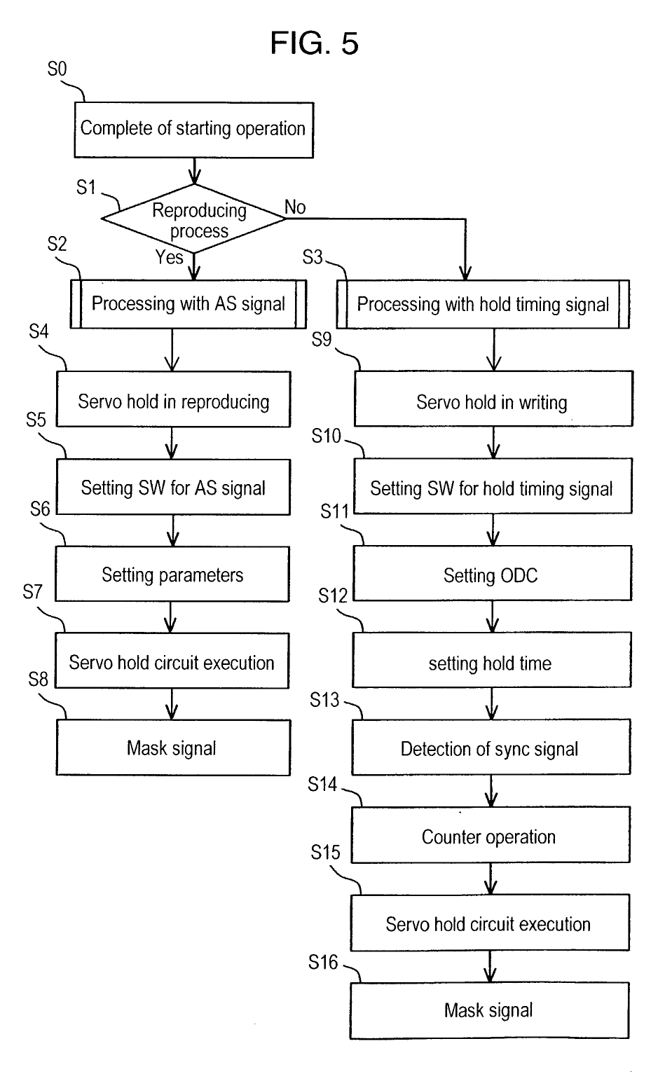

Next, a method of recording system servo control is described according to the flow charts shown in FIG. 1 and FIG. 5.

FIG. 5 is a flow chart of servo holding in exemplary embodiments 1 and 2 of the present invention. When the optical disk 101 is set in the optical disk drive of the exemplary embodiment 1, the type of optical disk 101 set in the disk is checked, the DC offset and level adjustments of the focus control signal and tracking control signal are made in accordance with the type of optical disk 101 set in the disk, and setting or other process of each signal processing LSI is executed in accordance with type of optical disk 101 set in the disk, and thereby, the starting operation of the optical disk is normally completed in accordance with the optical disk drive of the exemplary embodiment 1. (Step S0)

After completion of the starting operation, it is decided whether the reproducing system processing has to be executed or not. (Step S1) Here, when a demand for data reading is generated from the host PC 122, the ODC 120 of FIG. 1 generates the deciding signal for normal reproducing process. (Step S2)

On the other hand, when a demand for data recording is generated from the host PC 122, the ODC 120 automatically supplys the deciding signal for recording process according to the recording point. In case the deciding signal indicates the execution of recording process, servo control process by hold timing signal is executed in the control method of the present invention. (Step 3)

Entering the servo control process routine (step S9) for writing servo hold process, in the control method of exemplary embodiment 1, the servo hold circuit 124 in FIG. 1 is set to a hold timing signal system. That is, the switch 303 selects the hold timing signal 207. (Step 10)

Next, the setting of timing register 123 is executed. And then, the setting for designating the sector timing to output the mask signal from the writing point, and the setting of output timing in the sector reached are executed by the timing register 123 of ODC 120 (Step S11). Thus, it is possible to hold the servo control in sector timing before or after the writing point and at an predetermined time in the sector.

Next, the setting of hold time is executed for deciding the length of time to hold the servo control. (Step S12)

Subsequently, when a sector where the intended output timing exists is reached, the detected sync signal is generated. (Step S13)

When the hold timing signal output circuit 125 of FIG. 1 receives the sync signal, the internal counter simultaneously starts operating. (Step S14)

When the internal counter reaches the point of output timing in the sector, the hold timing signal is supplied to the servo hold circuit 124, then the hold timing system servo hold circuit is operated. (Step S15)

The servo hold circuit 124 generates pulses with a time width set by the hold time from the rising edge or falling edge timing of the hold timing signal, and the mask signal 308 is supplied to the servo control system. (Step S16)

In this servo control method described above, during the transfer from data reading out of the optical disk 101 to data writing into the optical disk 101, a mask signal is generated for holding the tracking control and the focus control while the TE signal and FE signal generated by the AGC block 110 are in a transient state. In this way, it is possible to prevent servo oscillation and breakdown in a transient state. Also, in the case of reversed transfer, a similar effect can be obtained during the transfer from data writing into the optical disk 101 to data reproducing out of the optical disk 101.

Next, in the optical disk drive of the exemplary embodiment 2, description is made with respect to the tracking control and focus control in inrush of the optical pickup from the data recorded area to the data non-recorded area during normal data reproducing out of the optical disk 101. Since the optical disk drive of exemplary embodiment 2 is basically same in configuration as in the exemplary embodiment 1, executing the operation by switching the servo hold circuit 124 of the optical disk drive in the exemplary embodiment 1, the description in the exemplary embodiment 2 is also made with reference to FIG. 1.

When a demand for data reading is generated from the host PC 122 to the optical disk drive of the exemplary embodiment 2, the ODC 120 supplies a control signal to the servo hold circuit 124 in order to change over the setting to AS signal processing system. The operation of the servo hold circuit 124 in the AS signal processing system is described hereinafter with reference to FIG. 3 and FIG. 5.

Setting demand control signal 309 for changeover to AS signal processing system is handed over from the host PC 122 to the control register 306, and the control register 306 controls the changeover so that the output of comparator 302 flows to time hold circuit 304. That is, the switch 303 is operated so that the AS signal flows to the time hold circuit 304. Also, in AS polarity switching section 301, processing is executed for setting the polarity of AS signal 307. Generally, it is designed that the AS signal 307 is increased with increase in the amount of light, but the polarity is reversed in some of optical disk drives. This problem may be solved by executing the polarity setting.

Further, the control register 306 sets the threshold value (DC level) of AS signal 307, a reference for non-recorded area decision, in the area decision reference signal level setting section 305. Threshold setting is described hereinafter with reference to FIG. 4 again. In FIG. 4, period 401 shows the data recorded area, period 402 is the data non-recorded area, period 404 is the transient response time until TE signal 405 is stabilized at a constant amplitude level by AGC circuit 110, and time 406 shows the point of transfer from the non-recorded area to the recorded area in normal reproducing mode. Incidentally, putting it in the exemplary embodiment 1, period 401 corresponds to the reading operation in the recorded area during data recording operation, and time 402 corresponds to the recording operation in the data non-recorded area during data recording operation, and time 406 corresponds to the point of transfer from normal reproducing to recording operation.

When the optical pickup 102 in the optical disk drive of the exemplary embodiment 2 moves from the data recorded area to the data non-recorded area during normal reproducing operation, the DC level of AS signal 403 and the amplitude level of TE signal 405 fluctuate at the area transfer point, time 406, as shown in FIG. 4. This completely holds true for FE signal as well, and so in the case of transfer from normal reproducing mode to recording operation in the exemplary embodiment 1 as described above.

AS signal 403 and TE signal 405 or FE signal are always fluctuate in same area due to variation in the amount of reflected light, but the amount of fluctuation is less enough as compared with the amount of alteration during transfer. Accordingly, the decision can be made on the area by setting the threshold of Vref control 305 on the basis of the alteration amount of AS signal 403. Incidentally, the threshold can be properly set, for which there is no predetermined standard.

In FIG. 3 and FIG. 5, AS signal 307 is compared with the threshold that is set as described above by the comparator 302 via POL 301 and is delivered to the time hold circuit 304 via the switch 303. The operation of the time hold circuit 304 is just as described above, and its description is omitted here.

When the optical pickup 102 moves from the data recorded area in normal reproducing mode shown by period 401 to the data non-recorded area shown by period 402, the time hold circuit 304 of the exemplary embodiment 2, same as in the exemplary embodiment 1, generates mask signal 308 from the servo hold circuit 124 in order to hold the tracking control and the focus control for the period 404 in which TE signal 405 and FE signal generated by AGC block 110 are in a transient state. Thus, it is possible to prevent the oscillation and breakdown of servo control in a transient state.

Next, a control method for normal reproducing system in the exemplary embodiment 2 is described hereinafter with reference to the flow charts shown in FIG. 1 and FIG. 5.

When the optical disk 101 is set in the optical disk drive of the exemplary embodiment 2, processes such as disk discrimination for checking the type of the optical disk 101, signal adjustments such as DC offset adjustment and level adjustment of focus and tracking control signals according to the type of the optical disk 101, and setting of each signal processing LSI according to the type of the optical disk 101 are respectively executed. When the optical disk 101 is compatible with the optical disk drive, the starting process is normally completed. (Step S0) After completion of the starting process, the ODC 120 of FIG. 1 generates a decision signal for normal reproducing operation when a demand for data reading is generated from the host PC 122 of FIG. 1. (Step S1) In the control method of the exemplary embodiment 2, servo control processing by AS signal is executed. (Step S2)

Thus, the operation enters into the servo control processing routine for the reproduce system servo hold process. (Step S4)

In the control method in the exemplary embodiment 2, the input signal of servo hold circuit 124 in FIG. 1 is set to the AS signal system. That is, the switch 303 selects the output of comparator 302. (Step S5)

Next, the hold time is set for deciding the length of time of holding the servo control, and simultaneously, threshold setting and AS polarity setting are executed for making the area decision with respect to the data recorded area and the data non-recorded area. (Step S6)

When the DC level of AS signal input to the servo hold circuit 124 of FIG. 1 exceeds the threshold set in the step S6, the AS system of servo hold circuit 124 is operated. (Step S7)

The servo hold circuit 124 generates pulses with the width of time set by the hold time from the rising edge or falling edge timing of the output signal of comparator 302 in accordance with the hold time setting, and the mask signal 308 is supplied to the servo control system. (Step S8) In the servo control method in the exemplary embodiment 2, when the optical pickup 102 moves from the data recorded area 401 in normal reproducing mode to the data non-recorded area 402, mask signal 308 is generated for holding the tracking control and the focus control for the period 404 in which the TE signal 405 and FE signal generated by AGC block 110 are in a transient state. In this way, it is possible to prevent servo oscillation and breakdown in a transient state.

As described above, in the present invention, the optical pickup 102 moves from the data recorded area to the data non-recorded area in normal reproducing mode, and the optical pickup 102 generates mask signal 308 for holding the tracking control and the focus control during the period of transfer between data reading out of the optical disk and data writing into the optical disk. In this way, the present invention is able to avoid unstable servo operation due to the transient response state of TE signal and FE signal generated by AGC circuit 110, and to provide an optical disk drive capable of preventing the oscillation and breakdown of servo control in a transient response state.

Thus, according to the present invention, when the optical pickup moves from the data recorded area to the data non-recorded area in normal reproducing mode, and during the period of transfer from the data reading out of the optical disk 601 to the data writing into the optical disk 601, it is possible to prevent servo oscillation and breakdown in the transient response state of TE signal and FE signal generated by AGC circuit.

What is claimed is:

1. An optical disk drive apparatus in which an optical detector converts a reflected laser beam from an optical disk into an electric signal, tracking control is executed by using the variation of said electric signal, and focus control is executed thereby, comprising:
a control section which takes a timing of variation in signal amplitude of tracking error signal as process start timing to meet a demand for data recording or a demand for data reading; and
a hold timing signal output circuit which generates a mask signal to hold said tracking control in timing before or after variation of said signal amplitude.

2. An optical disk drive apparatus in which an optical detector converts a reflected laser beam from an optical disk into an electric signal, tracking control is executed by using the variation of said electric signal, and focus control is executed thereby, comprising:
a control section which takes a timing of variation in signal amplitude of focus error signal as process start timing to meet a demand for data recording or a demand for data reading; and
a hold timing signal output circuit which generates a mask signal to hold said focus control in timing before or after variation of said signal amplitude.

3. An optical disk drive apparatus in which an optical detector converts a reflected laser beam from an optical disk into an electric signal, tracking control is executed by using the variation of said electric signal, and focus control is executed thereby, comprising:
a control section which takes a timing of variation in signal amplitude of tracking error signal generated due to the area difference of said reflected laser beam when an optical pickup moves between a data recorded area and a data non-recorded area in said optical disk as the timing of signal level alteration of AS signal; and
a hold timing signal output circuit which generates a mask signal to hold said tracking control in timing before or after variation of said signal amplitude.

4. An optical disk drive apparatus in which an optical detector converts a reflected laser beam from an optical disk into an electric signal, tracking control is executed by using the variation of said electric signal, and focus control is executed thereby, comprising:
a control section which takes a timing of variation in signal amplitude of focus error signal generated due to the area difference of said reflected laser beam when an optical pickup moves between a data recorded area and a data non-recorded area in said optical disk as the timing of signal level alteration of AS signal; and
a hold timing signal output circuit which generates a mask signal to hold said focus control in timing before or after variation of said signal amplitude.

5. A servo control method for an optical disk drive in which an optical detector converts a reflected laser beam from an optical disk into an electric signal, tracking control is executed by using the variation of said electric signal, and focus control is executed thereby,
wherein said optical disk drive comprises:
a control section which takes a timing of variation in signal amplitude of tracing error signal as process start timing to meet a demand for data recording or a demand for data reading;
a hold timing signal output circuit which generates a mask signal to hold said tracking control in timing before or after variation of said signal amplitude, and
a recording process includes:
a timing setting step for setting the timing of generating said mask signal; and
a hold time setting step for setting said hold time, and
when said control section takes said process start timing, it generates said mask signal to hold said tracking control in accordance with settings in said timing setting step and said hold time setting step.

6. A servo control method for an optical disk drive in which an optical detector converts a reflected laser beam from an optical disk into an electric signal, tracking control is executed by using the variation of said electric signal, and focus control is executed thereby,
wherein said optical disk drive comprises:
a control section which takes the timing of variation in signal amplitude of focus error signal as process start timing to meet a demand for data recording or a demand for data reading;
a hold timing signal output circuit which generates a mask signal to hold said focus control in timing before or after variation of said signal amplitude, and
a recording process includes:
a timing setting step for setting the timing of generating said mask signal; and
a hold time setting step for setting said hold time, and
when said control section takes said process start timing, it generates said mask signal to hold said focus control in accordance with settings in said timing setting step and said hold time setting step.

7. A servo control method for an optical disk drive in which an optical detector converts a reflected laser beam from an optical disk into an electric signal, tracking control is executed by using the variation of said electric signal, and focus control is executed thereby,
wherein said optical disk drive comprises:
a control section which takes the variation of AS signal as process start timing to meet a demand for data reading;
a hold timing signal output circuit which generates a mask signal to hold said tracking control in timing before or after variation of said AS signal amplitude, and
a recording process includes:
a threshold setting step for generating said mask signal when the variation of said AS signal exceeds a specified threshold; and
a hold time setting step for setting said hold time, and
when said control section takes said process start timing, it generates said mask signal to hold said tracking control in accordance with setting in said hold time setting step.

8. A servo control method for an optical disk drive in which an optical detector converts a reflected laser beam from an optical disk into an electric signal, tracking control is executed by using the variation of said electric signal, and focus control is executed thereby,
wherein said optical disk drive comprises:
a control section which takes the variation of AS signal as process start timing to meet a demand for data reading;
a hold timing signal output circuit which generates a mask signal to hold said tracking control in timing before or after variation of said AS signal amplitude, and
a recording process includes:
a threshold setting step for generating said mask signal when the variation of said AS signal exceeds a specified threshold; and
a hold time setting step for setting said hold time, and
when said control section takes said process start timing, it generates said mask signal to hold said focus control in accordance with setting in said hold time setting step.
